(19) United States
(12) Patent Application Publication
(10) Pub. No.: US 2026/0219114 A1
(43) Pub. Date: Jul. 30, 2026

(54) SENSORS

(71) Applicant: CRYOTECHNICS, LLC, Stuart, FL (US)

(72) Inventors: Adam KURLAND, Stuart, FL (US); David WEDEKIND, Stuart, FL (US)

(21) Appl. No.: 19/150,282

(22) PCT Filed: Jan. 22, 2024
(86) PCT No.: PCT/US2024/012324

§ 371 Date: Jul. 23, 2025

Related U.S. Application Data
(60) Provisional application No. 63/440,547, filed on Jan. 23, 2023.

(51) Int. Cl. G01K 13/00; B23K 26/042; B23K 26/36; G01K 7/18

(52) U.S. Cl. CPC G01K 13/006; B23K 26/042; B23K 26/36; G01K 7/18; G01K 2203/00

(57) ABSTRACT

The present invention provides a method to calibrate sensors and use of such sensors. In particular, the method of calibrating sensors can be carried out using ablation. The present invention also provides a method of generating a sensor by a direct electrical and/or mechanical attachment of surface-mount technology and surface mount devices to bonded, flexible, multiconductor ribbon cable.

### CROSS-REFERENCE TO RELATED APPLICATIONS

This application incorporates by reference and claims priority to and the benefit of U.S. Provisional Patent Application No. 63/440,547, filed on Jan. 23, 2023.

### FIELD

The present invention generally pertains to thermometry and cryogenic devices.

### BACKGROUND

The detection of the extremely low temperatures of cryogenic environments is a critical aspect in acquiring vital insights into the state, security, and operational condition of various devices and processes. This is particularly significant in industrial processes and advanced technologies where precise temperature measurement and control below approximately −150° C. (123.15K) are indispensable for the optimal functioning of the process environment, ensuring efficiency, and producing desired outputs. The applications of cryogenic temperature sensing span diverse industries, encompassing aerospace, medical, national security and defense, and semiconductor industries. Within the realm of advanced technologies, such as medical imaging, quantum computing, and superconducting applications, there is a reliance on, and often utilization of, unique material characteristics and behaviors of systems that become prominent at cryogenic temperatures. In addition, ultra-low temperatures contribute to stability, resolution, and ultimately, control, of specific processes. To address the specific requirements of these high-tech domains, there is a growing need for accurate and reliable cryogenic thermometers that are compatible with the unique process environments within a specific set of applications as well as compatible across a multitude of process disciplines.

The thermal-electrical performance of thick film based resistive cryogenic thermometers varies widely from batch to batch and across manufacturers. Even a device with an identical part number from the same manufacturer produced today as a part produced 25 years ago may not provide the same temperature dependent performance required to meet the original specifications or intentions of the device for the intended applications. This poses a serious risk to manufacturer and end-users alike since the expectation is that the devices shall perform to predefined and acceptable standards and should be interchangeable across any number of devices over time. While many thermometers today are manufactured to conform to international standards like IEC-60751 (based on ITS-90) for platinum resistance thermometers, there is yet no standard for resistance- or voltage-based thermometers in the deep-cryogenic or ultra-low temperature (ULT) cryogenic regime. For this reason, it often is necessary to calibrate a sensor and to provide a look-up table from the calibration or a calibration equation and coefficients to the end-user for interpolation of measured data. To calibrate thick film resistance sensors, for example, the industry practice requires the addition of resistive material with a near-zero temperature coefficient of resistance. This process is non-trivial and requires a great deal of skill and time on the part of a specially trained worker. The reliance on manual craft imparts a limit to the manufacturability of these devices. The present invention provides an operator-independent method to generate sensors by adjusting directly the native resistance of the film thereby ensuring performance standards and improving device reliability.

### SUMMARY

The present invention relates to sensors. In one exemplary embodiment, the instant invention is directed towards a method to generate a sensor, comprising directing a cutting beam from a cutting beam source onto to a surface of a film resistor; and partially cutting into a surface of a film resistor based on a trim parameter using the cutting beam to generate the sensor, wherein the trim parameter comprises an amount by which the surface can be partially cut.

In one aspect of the present embodiment, the film resistor can be connected to a digital multimeter capable of measuring resistance. The digital multimeter can have a broad measurement range to accommodate a broad temperature range.

In one aspect of the present embodiment, the trim parameter further comprises a cut speed. In another aspect of the present embodiment, the trim parameter further comprises a laser wavelength.

In one aspect of the present embodiment, the cutting beam source can be a laser.

In one aspect of the present embodiment, the trim parameter can be determined based on a selected temperature coefficient of resistance. In another aspect of the present embodiment, the trim parameter can be determined by measuring a first resistance of the film resistor at a first temperature. In yet another aspect of the present embodiment, the trim parameter can be determined by comparing the first resistance of the film resistor and the second resistance of the film resistor, wherein the second resistance can be a predetermined resistance.

In one aspect of the present embodiment, the trim parameter can be selected to generate a sensor with a predetermined resistance value. In one aspect of the present embodiment, the sensor can measure temperature between about 0.005 K to about 0.040 K. The ranges can be narrowed or broadened.

In one aspect of the present embodiment, the partial cutting can be performed manually. In one aspect of the present embodiment, the partially cutting can be fully or partially automated. In a specific aspect of the present embodiment, the automation can be performed using robotic translation, computer-controlled lasing, and machine vision.

In one aspect of the present embodiment, the method can further comprise monitoring the second resistance by a reference device at the time when the surface can be being partially cut.

In one exemplary embodiment, the instant invention is directed towards a method to generate a cryogenic sensor, comprising directing a cutting beam from a cutting beam source onto to a surface of a film resistor; and partially cutting into a surface of a film resistor based on a trim parameter using the cutting beam to generate the sensor, wherein the trim parameter comprises an amount by which the surface can be partially cut.

In one aspect of the present embodiment, the film resistor can be connected to a digital multimeter capable of measuring resistance. The digital multimeter can detect a cryogenic temperature range.

In one aspect of the present embodiment, the trim parameter further comprises a cut speed. In another aspect of the present embodiment, the trim parameter further comprises a laser wavelength.

In one aspect of the present embodiment, the cutting beam source can be a laser.

In one aspect of the present embodiment, the trim parameter can be determined based on a selected temperature coefficient of resistance. In another aspect of the present embodiment, the trim parameter can be determined by measuring a first resistance of the film resistor at a first temperature. In yet another aspect of the present embodiment, the trim parameter can be determined by comparing the first resistance of the film resistor and the second resistance of the film resistor, wherein the second resistance can be a predetermined resistance.

In one aspect of the present embodiment, the trim parameter can be selected to generate a sensor with a predetermined resistance value. The ranges can be narrowed or broadened.

In one aspect of the present embodiment, the partially cutting can be performed manually. In one aspect of the present embodiment, the partially cutting can be fully or partially automated. In a specific aspect of the present embodiment, the automation can be performed using robotic translation, computer-controlled lasing, and machine vision.

In one aspect of the present embodiment, the method can further comprise monitoring the second resistance by a digital thermometer at the time when the surface can be being partially cut.

In one exemplary embodiment, the instant invention is directed towards a method of generating a cryogenic sensor, comprising ablating at least a part of an insulation on a ribbon cable to expose a pattern of at least one conductor in the ribbon cable; placing a surface mount device on said exposed ribbon cable on, wherein the placing can be such that a pattern on the exposed ribbon cable at least partially matches an electrode footprint of the surface mount device; and attaching the surface mount device to the exposed ribbon cable to generate the cryogenic sensor.

In one aspect of the present embodiment, the ribbon cable comprises more than one individual wire. In another aspect of the present embodiment, the ribbon cable comprises two individual wires. In another aspect of the present embodiment, the ribbon cable comprises three individual wires. In yet another aspect of the present embodiment, the ribbon cable comprises four individual wires. In yet another aspect of the present embodiment, the ribbon cable comprises more than four individual wires

In one aspect of the present embodiment, the ribbon cable comprises more than one individual wire, wherein the individual wires are bonded together with a flexible adhesive.

In one aspect of the present embodiment, the insulation can be of polymeric material. In one aspect of the present embodiment, the ablation can be performed using a laser beam. In another aspect of the present embodiment, the ablation can be performed using a pulsed laser beam. In yet another aspect of the present embodiment, the ablation can be performed manually. In yet another aspect of the present embodiment, the ablation can be fully or partially automated. The automation can be performed using robotic translation, computer-controlled lasing, and machine vision.

In one aspect of the present embodiment, the ribbon cable can be mounted on a translating fixture prior to ablation. In one aspect of the present embodiment, the attaching can be performed by soldering. The soldering of the surface mount device to the exposed ribbon cable can be performed by providing a heat source. In one aspect of the present embodiment, the method can further comprise curing the soldered exposed ribbon cable to the surface mount device. In another aspect of the present embodiment, the attaching can be performed using an adhesive.

In one aspect of the present embodiment, the ablation of the ribbon cable can be performed based on a predetermined trimming pattern. In one aspect of the present embodiment, the placing of said surface mount device on said exposed ribbon cable can be performed manually or using a robot.

In one aspect of the present embodiment, the method can further comprise modifying the ribbon cable to provide at least one electrical circuit features.

In one exemplary embodiment, the instant invention is directed towards a method of generating a sensor, comprising ablating at least a part of an insulation on a ribbon cable to expose a pattern of at least one conductor in the ribbon cable; placing a surface mount device on said exposed ribbon cable on, wherein the placing can be such that a pattern on the exposed ribbon cable at least partially matches an electrode footprint of the surface mount device; and attaching the surface mount device to the exposed ribbon cable to generate the cryogenic sensor.

In one aspect of the present embodiment, the ribbon cable comprises more than one individual wire. In another aspect of the present embodiment, the ribbon cable comprises two individual wires. In another aspect of the present embodiment, the ribbon cable comprises three individual wires. In yet another aspect of the present embodiment, the ribbon cable comprises four individual wires

In one aspect of the present embodiment, the ribbon cable comprises more than one individual wire, wherein the individual wires are bonded together with a flexible adhesive.

In one aspect of the present embodiment, the insulation can be of polymeric material. In one aspect of the present embodiment, the ablation can be performed using a laser beam. In another aspect of the present embodiment, the ablation can be performed using a pulsed laser beam. In yet another aspect of the present embodiment, the ablation can be performed manually. In yet another aspect of the present embodiment, the ablation can be fully or partially automated. The automation can be performed using robotic translation, computer-controlled lasing, and machine vision.

In one aspect of the present embodiment, the ribbon cable can be mounted on a translating fixture prior to ablation. In one aspect of the present embodiment, the attaching can be performed by soldering. The soldering of the exposed ribbon cable to the surface mount device can be performed by providing a heat source. In one aspect of the present embodiment, the method can further comprise curing the soldered exposed ribbon cable to the surface mount device. In another aspect of the present embodiment, the attaching can be performed using an adhesive.

In one aspect of the present embodiment, the ablation of the ribbon cable can be performed based on a predetermined trimming pattern. In one aspect of the present embodiment, the placing of said surface mount device on said exposed ribbon cable can be performed manually or using a robot.

In one aspect of the present embodiment, the method can further comprise modifying the ribbon cable to provide at least one electrical circuit features.

In one exemplary embodiment, the instant invention is directed towards a method of generating a sensor, ablating at least two parts of an insulation on a ribbon cable to expose pattern of at least two conductors in the ribbon cable; placing at least two surface mount devices on said exposed ribbon cable on, wherein the placing can be such that at least two patterns on the exposed ribbon cable at least partially matches an electrode footprint of the surface mount devices; and attaching the at least two surface mount devices to the exposed ribbon cable to generate the sensor.

In one aspect of the present embodiment, the ribbon cable comprises more than one individual wire. In another aspect of the present embodiment, the ribbon cable comprises two individual wires. In another aspect of the present embodiment, the ribbon cable comprises three individual wires. In yet another aspect of the present embodiment, the ribbon cable comprises four individual wires.

In one aspect of the present embodiment, the sensor can be a cryogenic sensor.

In one aspect of the present embodiment, the at least two sensors are two. In another aspect of the present embodiment, the at least two sensors are three. In another aspect of the present embodiment, the at least two sensors are four.

In one aspect of the present embodiment, the ribbon cable comprises more than one individual wire, wherein the individual wires are bonded together with a flexible adhesive.

In one aspect of the present embodiment, the insulation can be of polymeric material. In one aspect of the present embodiment, the ablation can be performed using a laser beam. In another aspect of the present embodiment, the ablation can be performed using a pulsed laser beam. In yet another aspect of the present embodiment, the ablation can be performed manually. In yet another aspect of the present embodiment, the ablation can be fully or partially automated. The automation can be performed using robotic translation, computer-controlled lasing, and machine vision.

In one aspect of the present embodiment, the ablation of the ribbon cable can be mounted on a translating fixture prior to ablation. In one aspect of the present embodiment, the attaching can be performed by soldering. The soldering of the exposed ribbon cable to the surface mount device can be performed by providing a heat source. In one aspect of the present embodiment, the method can further comprise curing the soldered exposed ribbon cable to the surface mount device. In another aspect of the present embodiment, the attaching can be performed using an adhesive.

In one aspect of the present embodiment, the ablation of the ribbon cable can be performed based on a predetermined trimming pattern. In one aspect of the present embodiment, the placing of said surface mount device on said exposed ribbon cable can be performed manually or using a robot.

In one aspect of the present embodiment, the method can further comprise modifying the ribbon cable to provide at least one electrical circuit features.

### DETAILED DESCRIPTION

The present invention discloses methods to generate sensors that can be modulated to achieve the required performance characteristic at a desired temperature or across a temperature range. The present invention can be applicable to sensors made by any manufacturer and across any temperature range.

### Examples

### Example 1. Sensors by Ablating Insulation on a Ribbon Cable

The probe end of a multiconductor electrical ribbon cable is mounted to a translating fixture in front of a lasing apparatus and aligned coarsely within the field of view of the inspection microscope. Based on both the size of the component and the component's electrode footprint, a trimming pattern is determined and translating coordinates are defined. The laser is pulsed at a low energy to provide the visible spot for fine adjustment and positioning to the home coordinate as visualized through the inspection microscope. The laser energy is increased until visible removal of insulation through the inspection microscope. Lasing continues as the translating fixture moves the conductors along the paths defined for insulation removal.

Once the electrode pattern has been transferred to the conductors by way of insulation ablation, the lasing ceases and the ribbon is removed from the translating fixture.

The aforementioned steps can be performed completely manually by an operator, or semi- or fully automatically using some or all of robotic translation, computer-controlled lasing, and machine vision.

The aforementioned steps may apply to singular lengths of cut ribbon cable, or to an undefined length of cable that is fed automatically and subjected to ablation at prescribed distances.

The stripped multiconductor ribbon cable is provided to a fixture for SMD component mounting. Solder or electrically conductive adhesive is applied to the exposed conductors of the ribbon cable that were ablated previously. The SMD component is aligned to the exposed conductors on the ribbon and placed, either by hand or by robot, onto the ribbon cable. If SMD resistor, the component is placed such that the active film is “up.”

If solder is used, heat is applied just long enough to reflow the solder and affix the SMD component. If conductive adhesive is used, the assembly is cured according to the curing schedule.

### Example 2. Sensors by Modifying the Surface of a Film Resistor

The SMD resistor device under test (DUT) mounted on the ribbon cable is measured at room temperature. Electrical connections to the measurement instrumentation are made at the opposite end of the ribbon cable. The DUT is submerged into an open bath of liquid helium. The resistance of the DUT is measured while simultaneously recording the temperature of the liquid helium by means of a calibrated reference device. The target resistance for calibration is calculated using the liquid helium reference temperature and a standard temperature versus resistance lookup table according to the application.

The difference between the measured resistance of the DUT in liquid helium and the target resistance at the reference temperature gives the amount of resistance overall that needs to be added or subtracted at the reference temperature. Due to the temperature coefficient of resistance, this value is NOT the amount of resistance to be added or subtracted at room temperature. The amount of resistance to be added or subtracted at room temperature is some percentage of the overall dR at the reference temperature (determined later).

The DUT, affixed to the probe end of the ribbon cable with the film side up, is mounted to a translating fixture in front of a lasing apparatus and aligned coarsely within the field of view of the inspection microscope. The opposite end of the cable is connected to the measurement instrumentation to provide live measurements for active trimming.

The laser is pulsed at a low energy to provide the visible spot for fine adjustment and positioning to the home coordinate where hypertrim is to occur. The laser energy is increased until the first measurable difference is seen in the measurement instrument. The laser is pulsed until the desired amount of resistance change has occurred. While the majority of this work involves increasing the film resistance, it is also possible to decrease the film resistance by a limited amount. This may be useful to further increase product yield.

The DUT is removed from the translating fixture and submerged into an open bath of liquid helium. The resistance of the DUT is measured while simultaneously recording the temperature of the liquid helium by means of a calibrated reference device.

The target resistance is determined as explained above. The dR is converted into a temperature value (the temperature error). If the temperature error is larger than the acceptable error as defined by the calibration accuracy requirement, the trimming is repeated. If the temperature error is within the acceptable error limits, the DUT is now a calibrated thermometric device that can be used as-is or packaged into various configurations.

1. A method of generating a cryogenic sensor, comprising
directing a cutting beam from a cutting beam source onto to a surface of a film resistor; and
partially cutting into a surface of a film resistor based on a trim parameter using the cutting beam to generate the cryogenic sensor, wherein the trim parameter comprises an amount by which the surface is partially cut.

2.-5. (canceled)

6. The method of claim 1, wherein the trim parameter is determined based on a selected temperature coefficient of resistance.

7. The method of claim 1, wherein the trim parameter is determined by measuring a first resistance of the film resistor at a cryogenic temperature by submerging the film resistor in a cryogenic medium.

8. The method of claim 7, wherein the trim parameter is determined by comparing the first resistance of the film resistor and the second resistance of the film resistor in a cryogenic medium, wherein the second resistance is a predetermined resistance.

9. (canceled)

10. The method of claim 1, wherein the trim parameter is selected to generate a cryogenic sensor with a predetermined resistance value.

11.-15. (canceled)

16. A method of generating a sensor, comprising
directing a cutting beam from a cutting beam source onto to a surface of a film resistor; and
partially cutting into a surface of a film resistor based on a trim parameter using the cutting beam to generate the sensor, wherein the trim parameter comprises an amount by which the surface is partially cut.

17.-22. (canceled)

23. The method of claim 16, wherein the trim parameter is determined by measuring a first resistance of the film resistor at a first temperature.

24. The method of claim 23, wherein the trim parameter is determined by comparing the first resistance of the film resistor and the second resistance of the film resistor, wherein the second resistance is a predetermined resistance.

25. The method of claim 16, wherein the trim parameter is selected to generate a sensor with a predetermined resistance value.

26.-30. (canceled)

31. A method of generating a cryogenic sensor, comprising:
ablating at least a part of an insulation on a ribbon cable to expose a pattern of at least one conductor in the ribbon cable;
placing a surface mount thermometric device on said exposed ribbon cable on, wherein the placing is such that a pattern on the exposed ribbon cable at least partially matches an electrode footprint of the surface mount device; and
attaching the surface mount device to the exposed ribbon cable to generate the cryogenic sensor.

32.-34. (canceled)

35. The method of claim 31, wherein the insulation is of polymeric material.

36.-50. (canceled)

51. A method of generating a sensor, comprising:
ablating at least a part of an insulation on a ribbon cable to expose a pattern of at least one conductor in the ribbon cable;
placing a surface mount device on said exposed ribbon cable on, wherein the placing is such that a pattern on the exposed ribbon cable at least partially matches an electrode footprint of the surface mount device; and
attaching the surface mount device to the exposed ribbon cable to generate the sensor.

52.-54. (canceled)

55. The method of claim 51, wherein the insulation is of polymeric material.

56.-62. (canceled)

63. The method of claim 51, wherein the attaching is performed by soldering.

64.-69. (canceled)

70. The method of claim 51, further comprising modifying the ribbon cable to provide at least one electrical circuit features.

71. (canceled)
